(19) United States
(12) Patent Application Publication
(10) Pub. No.: US 2014/0145524 A1
(43) Pub. Date: May 29, 2014

(54) ELECTRIC POWER TOOL

(71) Applicant: Hitachi Koki Co., Ltd., Tokyo (JP)

(72) Inventors: Hideyuki Tanimoto, Ibaraki (JP); Yoshihiro Nakano, Ibaraki (JP); Hiroki Uchida, Ibaraki (JP); Yoshihiro Komuro, Ibaraki (JP)

(73) Assignee: HITACHI KOKI CO., LTD., Tokyo (JP)

(21) Appl. No.: 14/090,299

(22) Filed: Nov. 26, 2013

(30) Foreign Application Priority Data
Nov. 28, 2012 (JP) 2012-259402
Nov. 28, 2012 (JP) 2012-259410

(51) Int. Cl. H02K 7/14; H02K 1/27

(52) U.S. Cl. CPC H02K 7/145; H02K 1/2706
USPC 310/50

(57) ABSTRACT

An electric power tool including: a motor; and a rotary impact mechanism configured to be driven by the motor, wherein the motor is configured such that a rotation speed thereof can be set within a range of 14600 to 19000 min⁻¹ when a motor torque is within a torque range during practical operation.

### CROSS-REFERENCE TO RELATED APPLICATIONS

This application claims priority from Japanese Patent Application No. 2012-259402 filed on Nov. 28, 2012 and Japanese Patent Application No. 2012-259410 filed on Nov. 28, 2012, the entire contents of which are incorporated herein by reference.

### TECHNICAL FIELD

Aspects of the present invention relates to an electric power tool including an impact tool, such as an impact driver. Further, aspects of the present invention relate to an electric power tool including a brushless motor.

### BACKGROUND

As an electric power tool capable of performing work, such as screw fastening, by rotating a brushless motor with an electric power from a battery pack, and applying a striking force to a front end tool with a rotary impact mechanism, an impact tool is widely known (see JP-A-2009-72889, JP-A-2010-99823)

In the impact tool described above, there is a problem in that great importance is placed on the fastening number of screws per charge and product downsizing, but the improvement of screw fastening speed has a low priority order, which cannot satisfy the speed required by the market.

Further, an electric power tool such as an impact driver employs a brushless motor as a drive source. The brushless motor generally has a rotor configuration in which a planar permanent magnet is inserted into and held by a magnet insertion hole of a rotor core provided to an outer circumference of a shaft (see JP-A-2009-72889, JP-A-2010-99823).

To obtain a high output, it is necessary to enlarge a surface area of the outer circumferential side of the permanent magnet to increase a flux content. Here, there is provided a configuration in which a tubular magnet is adhered to the surface of the rotor core. However, because of fixation using adhesion only, there is a problem that, for example, the tubular magnet idles when impact is applied thereto.

### SUMMARY

The present invention has been made in view of the above circumstance, and an object of the present invention is to provide an electric power tool capable of increasing a screw fastening speed, as compared to related art.

Further, another object of the present invention is, in a configuration in which a permanent magnet is installed to a magnet insertion portion of a rotor core, to provide an electric power tool capable of increasing a surface area of a magnet located at an outer circumferential side, as compared with a configuration of related art.

According to an aspect of the present invention, there is provided an electric power tool including: a motor; and a rotary impact mechanism configured to be driven by the motor, wherein the motor is configured such that a rotation speed thereof can be set within a range of 14600 to 19000 min⁻¹ when a motor torque is within a torque range during practical operation.

According to another aspect of the present invention, there is provided an electric power tool including: a motor; and a rotary impact mechanism configured to be driven by the motor, wherein the motor is configured such that a rotation speed thereof can be set within a range of 14600 to 19000 min⁻¹ when a motor torque is within at least a portion of a torque range of 0.15 to 0.20 N·m.

According to another aspect of the present invention, there is provided an electric power tool including: a motor; and a rotary impact mechanism configured to be driven by the motor, wherein the motor is a brushless motor, and wherein a stator of the motor has an outer diameter of 48.5±2 mm and has a tooth width of 5.4 to 6.6 mm.

According to another aspect of the present invention, there is provided an electric power tool including: a brushless motor including: a shaft; a rotor core provided to an outer circumference of the shaft; and a plurality of permanent magnets each disposed in a magnet insertion portion of the rotor core and provided along an outer peripheral surface of the rotor core, wherein an outer peripheral side surface of each permanent magnet has a curved surface which is curved so that a center of curvature is located at the shaft side.

According to another aspect of the present invention, there is provided an electric power tool including: a brushless motor including: a shaft; a rotor core provided to an outer circumference of the shaft; and a plurality of permanent magnets each disposed in a magnet insertion portion of the rotor core and provided along an outer peripheral surface of the rotor core, wherein an outer peripheral side surface of each permanent magnet has a plurality of planar surfaces which are provided along a curved surface which is curved so that the center of curvature is located at the shaft side.

According to another aspect of the present invention, there is provided an electric power tool including: a brushless motor including: a shaft; a rotor core provided to an outer circumference of the shaft; and a plurality of permanent magnets each disposed in a magnet insertion portion of the rotor core and provided along an outer peripheral surface of the rotor core, wherein an outer peripheral side surface of each permanent magnet is a planar surface which is provided along a curved surface which is curved so that the center of curvature is located at the shaft side, and wherein, for one pole of the rotor, two or more permanent magnets of the same pole are provided.

Optional combinations of the aforementioned constituting elements, and changes of the expressions of the present invention in the form of methods or systems are also effective as aspects of the present invention.

According to aspects of the present invention, an impact tool capable of increasing the screw fastening speed can be provided, as compared with the configuration of the related art.

Further, according to aspects of the present invention, the electric power tool capable of increasing the surface area of the magnet located at the outer circumferential side can be provided in the configuration in which the permanent magnet is installed to the magnet insertion portion of the rotor core, as compared with the configuration of the related art.

### BRIEF DESCRIPTION OF DRAWINGS

FIG. 1 is an internal configuration diagram of an electric power tool (impact driver) according to an embodiment of the present invention;

FIG. 2 is an enlarged view around a brushless motor 2 in FIG. 1;

FIG. 3 (3A to 3E) is a front view of a rotor of the brushless motor 2 (when seen in an axial direction);

FIG. 4 is a front view of the brushless motor 2 (when seen in the axial direction);

FIG. 5 is a graph showing the characteristic of a flux content (vertical axis) flowing in a tooth portion 33 and a tooth with (horizontal axis);

FIG. 6 is a graph showing the characteristic of a rotation speed (horizontal axis) of the brushless motor 2, a time (left vertical axis) required to fasten a screw of 120 mm, and an operating current (right vertical axis);

FIG. 7 is a graph showing the characteristic of the number of turns of a coil 35 and the rotation speed of the brushless motor 2; and

FIG. 8 is a graph showing torque and the rotation speed of the brushless motor 2.

### DETAILED DESCRIPTION

Hereinafter, preferred embodiments according to the present invention will be described with reference to the drawings. The same or similar components are denoted by the same reference numerals, and redundant description thereof will be omitted as appropriate. The embodiments have been described for exemplary purposes only, and are by no means intended to restrict the present invention. Also, it is not necessarily essential for the present invention that all the features or a combination thereof be provided as described in the embodiments.

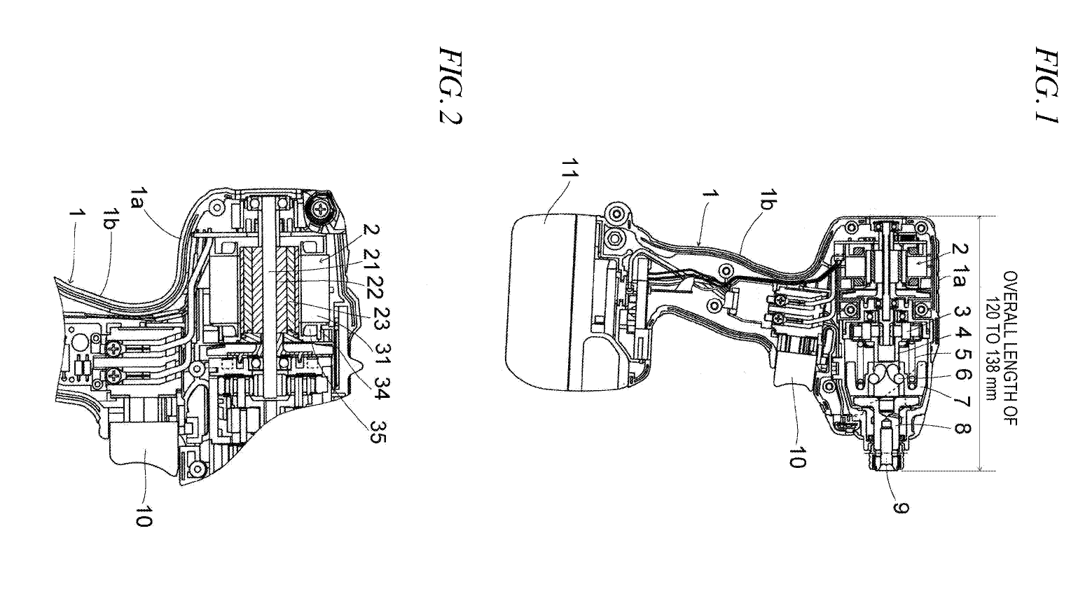

FIG. 1 is an internal configuration diagram of an electric power tool (impact driver) according to an embodiment of the present invention. A housing 1 of the electric power tool includes a power tool body 1a and a handle 1b. The handle 1b extends downward from an intermediate portion of the power tool body 1a, and the housing 1 is formed in a substantially T-shape as a whole. A brushless motor 2 and a rotary impact mechanism are installed in the power tool body 1a. That is, in the power tool body 1a, a spindle 4 is connected to the brushless motor 2 via a speed reduction mechanism (e.g., planetary gear mechanism), a hammer 7 is connected to the spindle 4 via a spring 5 (compression spring) and steel balls 6, and an anvil 8 is installed to a front end side of the hammer 7. A front end of the anvil 8 is provided with a front end tool attachment hole 9 for mounting a front end tool, such as a driver bit. At the time of work, such as screw fastening, if a user pulls a trigger 10 while holding the handle 1b with his or her hand, an electric power is supplied to the brushless motor 2 from a battery pack 11 attached to a lower end of the handle 1b, and the spindle 4 and the hammer 7 are rotated by rotation of the brushless motor 2, so that the hammer 7 applies a rotational impact force to the anvil 8. In this instance, since the configuration and operation of the rotary impact mechanism are known in the art, its more detailed description will be omitted herein.

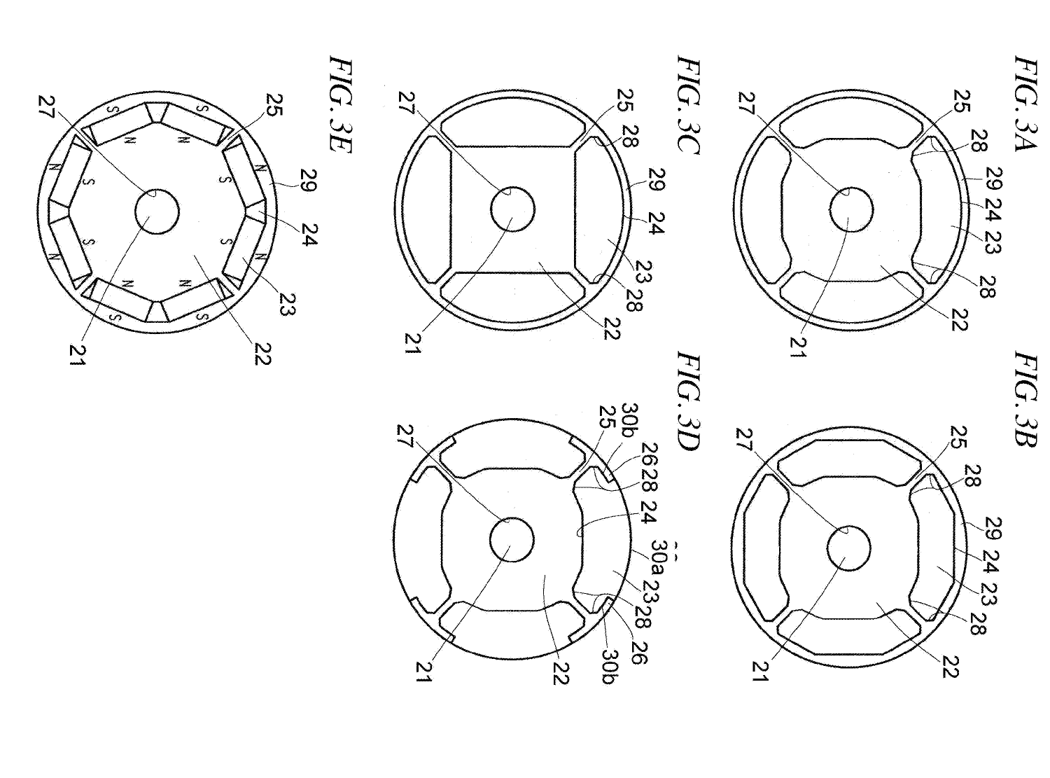

FIG. 2 is an enlarged view around the brushless motor 2 in FIG. 1. FIGS. 3A to 3E are front views illustrating a preferred embodiment of a rotor of the brushless motor 2 (when seen in an axial direction). FIG. 4 is a front view of the brushless motor 2 (when seen in the axial direction). However, FIG. 4 does not show an insulator 34 and a coil 35 which are illustrated in FIG. 2. As illustrated in FIG. 2, the brushless motor 2 is provided rear to or extends to portion of the power tool body 1a of the housing 1 to which the handle 1b is attached.

A rotor core 22 is provided around a shaft 21. The rotor core 22 has a cylindrical shape which is formed by stacking electromagnetic steel sheets, for example. As illustrated in FIG. 3, the rotor core 22 is formed with a shaft insertion hole 27 in the center thereof. In this embodiment, the rotor has four poles, and the rotor core 22 has four magnet insertion portions 24 around the shaft insertion hole 27. The adjacent magnet insertion portions 24 are separated by a partition portion 25. The shaft 21 penetrates through the shaft insertion hole 27, and the permanent magnet 23 is inserted into and held by each magnet insertion portion 24.

As illustrated in FIG. 4, a stator core 31 is held at the outer circumference of the rotor core 22 by the power tool body 1a of the housing 1. The stator core 31 has a yoke portion 32 and a tooth portion 33. The yoke portion 32 surrounds the rotor core 22 in a cylindrical shape, and the tooth portion 33 extends from the yoke portion 32 to the rotor core 22. In this embodiment, the stator has six slots, and six tooth portions 33 extend from the yoke portion 32 at an equal angular interval. An insulator 34 is interposed between the tooth portions 33, as illustrated in FIG. 2, and the coil 35 is wound around the respective tooth portions 33.

Variations in the shape of the permanent magnet 23 will be described with reference to FIGS. 3A to 3E.

In FIG. 3A, an outer peripheral side surface of the permanent magnet 23 is a curved surface which is curved so that a center of curvature is located at the shaft 21 side (preferably, a circular arc surface centered around the shaft 21), and is curved by an outer peripheral portion 29 of the rotor core 22. The inner peripheral side surface of each permanent magnet 23 has three planar surfaces (three planar surfaces provided along the circular arc surface centered around the shaft 21) to which the shaft 21 directly faces. Edges of both ends of the outer peripheral side surface and the inner peripheral side surface of the permanent magnet 23 are respectively chamfered to form a chamfered portion 28. As illustrated in FIG. 3A, since the outer peripheral side surface of the permanent magnet 23 is formed to have the curved surface, the surface area of the outer peripheral surface of the permanent magnet 23 is increased to increase the flux content, which is advantageous with respect to high output, as compared with the case of the related art where a planar permanent magnet is employed. Further, as compared with the case where the inner peripheral side surface of the permanent magnet 23 is formed in a rounded surface, since the inner peripheral side surface of the permanent magnet 23 is combined with planar surfaces having good processing precision, the impact is easily received by the surfaces, so that the permanent magnet is hardly broken when the impact is applied thereto. In addition, since the chamfered portions 28 are formed to remove a sharp portion, stress concentration is eliminated, so that the permanent magnet 23 is hardly broken. The portion of the power tool body 1a of the housing 1, which protrudes rearward than the portion to which the handle 1b is attached, is likely to be bent, and the brushless motor 2 extends therefrom. Accordingly, since the outer peripheral portion 29 serves as a damping spring to absorb the impact applied to the permanent magnet 23 in a radial direction, the permanent magnet 23 can be thinned, which is advantageous for cost reduction. Further, since the partition 25 extending in the radial direction serves as the damping spring to absorb the impact applied to the permanent magnet 23 in a circumferential direction, it is possible to reduce idling of the permanent magnet 23.

The permanent magnet 23 of this configuration may be used in general electric power tools, but is effectively used for an impact driver in which heavy impact is applied to the motor when working, as compared with the electric power tool such as a driver drill. As known in the art, the impact driver is configured in such a way that the hammer 7 strikes the anvil 8 to generate torque and thus transfer a rotating force to the front end tool attached to the front end tool attachment hole 9. The impact generated by the striking of the hammer 7 on the anvil 8 is transferred to the brushless motor 2. And this impact is transferred to the permanent magnets 23 inserted in the magnet insertion portion 24. In the case where the planar permanent magnet is used, like the related art, the outer peripheral portion 29 positioned at the outer circumferential side of the permanent magnet has a thickness from the permanent magnets to the outer peripheral portion in the radial direction becomes thick. The impact force transferred to the rotor is applied to the permanent magnets, but since the outer peripheral portion 29 is thick, the outer peripheral portion 29 cannot be deformed by the impact force to absorb it. For this reason, the permanent magnet may be broken. However, in this embodiment, since the permanent magnet is formed in the circular arc shape to make the outer peripheral portion 29 thin, even if impact is applied to the permanent magnet, the outer peripheral portion 29 is deformed to absorb the impact, thereby preventing the permanent magnet from being broken. In particular, in a case of using a samarium-cobalt magnet, which is susceptible to fracture, or a thin neodymium magnet as the permanent magnet, it is effective. That is, by combining the shape and arrangement of the permanent magnets in a manner as described above, the permanent magnets can be used for the electric power tool capable of generating a striking force, such as an impact driver.

FIG. 3B shows that the outer peripheral side surface of the permanent magnet 23 has three planar surfaces provided along a curved surface in which a center of curvature is located at the shaft 21 side (preferably, a circular arc surface centered around the shaft 21), different from FIG. 3A. In this instance, the surface area of the outer circumferential side of the permanent magnet 23 is increased to increase the flux content, which is advantageous in the high output, as compared with the case of the related art where a planar permanent magnet is employed. Other aspects in FIG. 3B are identical to those in FIG. 3A, and show the same working effect thereof.

FIG. 3C shows that the inner peripheral side surface of the permanent magnet 23 has a single planar surface, different from FIG. 3A. Further, both ends of the inner peripheral side surface of the permanent magnet 23 are not provided with the chamfered portion 28. Other aspects in FIG. 3B are identical to those in FIG. 3A, and show the same working effect thereof.

FIG. 3D shows that an arcuate curved surface 30a of the outer circumferential side of the permanent magnet 23 is exposed from the rotor core 22, and both end sides of the arcuate curved surface 30a in a direction about the axis is formed with a stepped surface 30b which is recessed from the arcuate curved surface 30a, different from FIG. 3A. Further, the magnet insertion portion 24 is the hole in FIG. 3A, but the magnet insertion portion 24 is a groove formed on the outer peripheral surface of the rotor core 22 in FIG. 3D. The rotor core 22 has a locking portion 26 which covers the stepped portion 30b of the permanent magnet 23. The locking portion 26 locks the stepped surface 30b to prevent the permanent magnet 23 from being released toward the outer circumferential side of the permanent magnet 23. Other aspects in FIG. 3D are identical to those in FIG. 3A, and show the same working effect thereof. Also, similar to the outer peripheral portion 29 in FIG. 3A, since the locking portion 26 is thin, as compared with the outer peripheral portion of the related art, the impact force applied to the permanent magnet can be absorbed, thereby preventing the breaking of the permanent magnet.

FIG. 3E shows that eight planar permanent magnets 23 are used for four poles of the rotor, that is, two permanent magnets 23 are used for one pole of the rotor. Two permanent magnets 23 which form one pair are provided along the curved surface of which a center of curvature is located at the shaft 21 side (preferably, a circular arc surface centered around the shaft 21). Four magnet insertion portions 24 (holes) receive and retain two permanent magnets 24 corresponding to the same pole of each rotor. As two permanent magnets 23 are used for one pole of the rotor, as illustrated in FIG. 3E, the surface area (surface area per pole) of the outer circumferential side of the permanent magnet 23 can be increased, as compared with the case where only one permanent magnet 23 is used for one pole of the rotor, thereby increasing the flux content, which is advantageous in high output. Also, since the thickness of the outer peripheral portion 29 is thin, the outer peripheral portion can be deformed to absorb the impact, when the impact is applied to the permanent magnet 23. Therefore, it is possible to prevent the breaking of the permanent magnet.

Now, various parameters of the stator side will be described.

The stator has an outer diameter (outer diameter of stator core 31) within a range of 48.5±2 mm. As the outer diameter of the stator is increased, the yoke portion 32 of the stator core 31 is thickened, which easily outputs the magnetic flux (advantageous to the high output). Also, since the coil of a thick wire diameter can be wound, the temperature rise can be reduced by decreased copper loss. Conventionally, the maximum outer diameter of the power tool body 1 a receiving the brushless motor 2 is determined by an outer diameter of a mechanism part (e.g., mechanism from the speed reduction mechanism 3 to the hammer 7) of the front end side of the brushless motor 2. Under the limitation in that the maximum outer diameter of the power tool body 1a should not be increased since it affects its workability, the outer diameter of the stator is set within the range of 48.5±2 mm which is substantially equal to the outer diameter of the mechanism part. In addition, the thickness (axial length (accumulated thickness) of the stator core 31) is set within a range of 8 to 12 mm, which is as long as possible under the limitation on the overall length of the electric power tool.

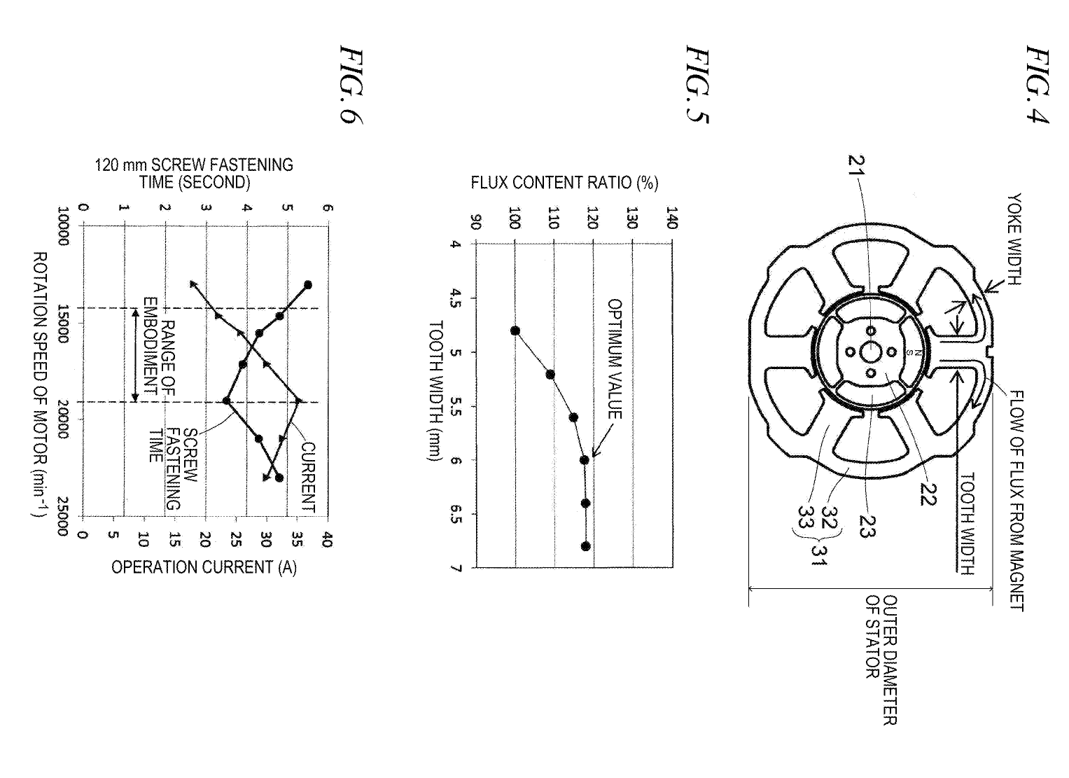

A tooth width (width of the tooth portion 33) is set within a range of 5.4 to 6.6 mm, and a yoke width (width of the yoke portion 32) is set to ½ of the tooth width. FIG. 5 is a graph showing the characteristic of the flux content (vertical axis) flowing in the tooth portion 33 and the tooth width (horizontal axis). The vertical axis illustrates ratios of the tooth width with respect to the flux content, in which the flux magnet is 100% at the tooth width of 4.8 mm. As illustrated in the drawing, it will be known that even though the tooth width is increased by 6 mm or more, since the flux content is hardly changed and does not contribute to the high output, the optimum value of the tooth width is 6 mm. For this reason, the tooth width is the proximity to 6 mm (6 mm±10%). Further, in the stator core 31, the flux content flowing in the yoke portion 32 is ½ of the flux content flowing in the tooth portion 33, as illustrated in FIG. 4.

FIG. 6 is a graph showing the characteristic of a rotation speed (horizontal axis) of the brushless motor 2, a time (left vertical axis) required to fasten a screw of 120 mm, and an operating current (right vertical axis). The rotation speed of the brushless motor 2 is a rotation speed when a motor torque of the brushless motor is 0.15 N·m, which is within a torque range (e.g., 0.15 to 0.20 N·m) of the brushless motor 2 during practical operation, and is varied by changing the number of turns of the coil 35. In this instance, the rotation speed according to the desired torque can be measured by a motor characteristic measuring device. Further, a voltage (voltage of the battery pack 11) applied to the brushless motor 2 is 14.4V, and a duty ratio is 100%. In general, there is a relationship in that if the number of turns of the coil is decreased, the rotation speed of the motor is increased, while if the number of turns of the coil is increased, the rotation speed of the motor is decreased. To speed up the screw fastening of for example, 5 seconds or less, it is necessary to increase the rotation speed of the brushless motor 2 by 14600 min⁻¹ (rpm) or more, as known from FIG. 6. As illustrated in FIG. 6, even if the rotation speed of the brushless motor 2 is increased by 19000 min⁻¹ or more, the time required for the screw fastening is not shortened, but rather is extended. The supposable reason is that, if the rotation speed of the brushless motor 2 is too high, a rotary impact mechanism can not follow. Accordingly, it is important to set the rotation speed of the brushless motor 2 within a range of 14600 to 19000 min⁻¹ (within the range denoted by a dotted line in FIG. 6). When a rated voltage of the battery pack 11 is within a range of 14.4 to 18V (maximum voltage 16 to 20V), the rotation speed of the brushless motor 2 is preferably set within the range of 14600 to 19000 min⁻¹ when the motor torque is within the entire torque range (e.g., 0.15 to 0.20 N·m) of the brushless motor 2 during the practical operation. For this reason, the outer diameter of the stator, the stator thickness, the tooth width, and the yoke width are set to the above-described range, and the number of turns of the coil 35 is set within a range of 8.5 to 11.5 turns/slot. In particular, in view of the balance between the operation current and the screw fastening time, 15600 min⁻ is best for the rotation speed of the brushless motor 2, and 10.5 turns/slot is best for the number of turns of the coil 35.

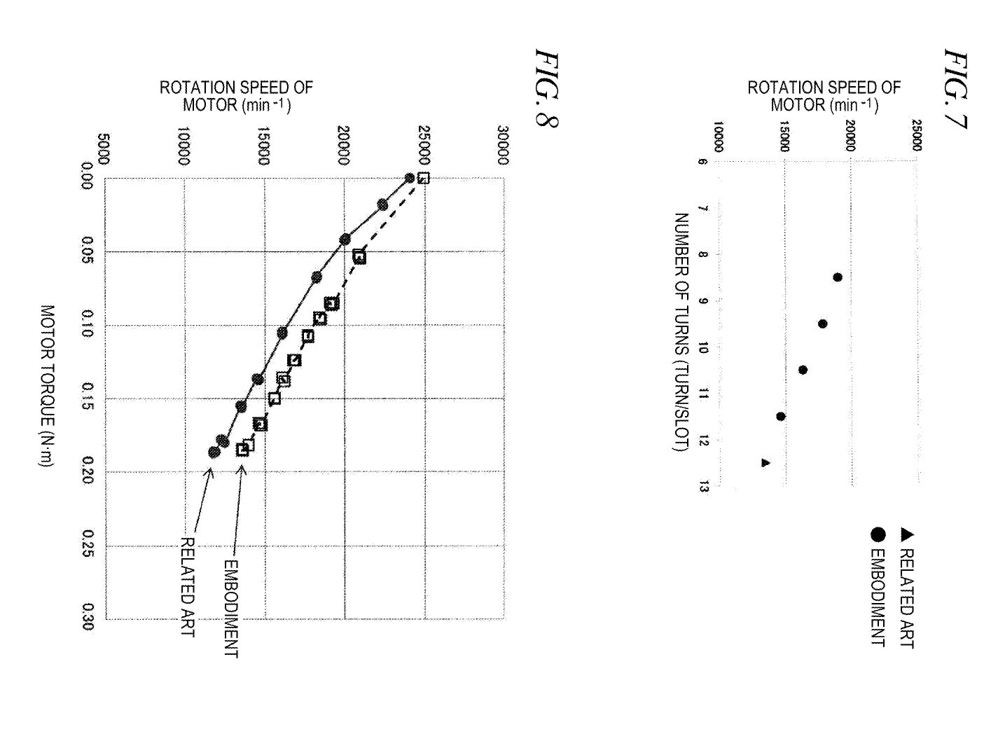

FIG. 7 is a graph showing the characteristic of the number of turns of the coil 35 and the rotation speed of the brushless motor 2. Since the number of turns of the related art (▴ in the drawing) is large, i.e., 12.5 turns/slot, the rotation speed is low, i.e., 13500 min⁻¹. In contrast, if the number of turns of the coil 35 ( in the drawing) is set to 8.5 to 11.5 turns/slot, the rotation speed can be set within the range of 14600 to 19000 min⁻. Meanwhile, a problem may occur in that if the operation current is too high, a temperature of the brushless motor 2 is raised. The wire diameter of the coil 35 is preferably thick as much as possible to reduce the copper loss, and is set within a range of 1.1 to 1.3 mm herein in view of the relationship with the slot size. Further, as illustrated in FIG. 1, the overall length of the electric power tool is set within a range of 120 to 138 mm. In this instance, a slot area (slot size) is proportional to the square of the outer diameter of the stator, in which the outer diameter of the stator is 48.5±2 mm (46.5 mm to 50.5 mm). Since the slot area is 28.7 mm² when the outer diameter of the stator is 48.5 mm, the minimum value of the slot area is 28.7×(46.5/48.5)²=26 4 mm², and the maximum value is 31.1 mm². Accordingly, 26.4 mm² to 31.1 mm² is best for the slot area.

Further, FIG. 8 is a graph showing the torque and the rotation speed of the brushless motor 2. In the related art (◯ in the drawing), it was not possible to set the rotation speed to 14600 min⁻¹ or lamer when the torque is within a range of 0.15 to 0.20 N·m. In contrast, it is possible to set the rotation speed of the brushless motor 2 within the range of 14600 to 19000 min^{-l} when the torque is within the range of 0.15 to 0.20 N·m by setting the outer diameter of the stator, the stator thickness, the tooth width, and the yoke width within the above-described ranges (□ in the drawing). In this instance, the characteristic is shown in the case where the tooth width is 6.0 mm, and the yoke width is 3.0 mm in the state in which the battery pack 11 applying the power to the brushless motor 2 is fully charged with the rated voltage 14.4V.

According to this embodiment, the following effects can be obtained.

(1) As described in FIGS. 3A to 3E, since the surface area of the outer peripheral side of the permanent magnet 23 is large as compared with the related art, the flux content is increased, which is advantageous in high output. Further, even if a cheap magnet, for example, a samarium-cobalt magnet, is employed instead of an expensive neodymium magnet, the required flux content can be obtained, which is advantageous in reducing cost.

(2) Since the rotation speed of the brushless motor 2 can be set within the range of 14600 to 19000 min⁻¹ when the motor torque is within a torque range during practical operation of the impact tool, the screw fastening time per screw can be shortened, as compared with the configuration of the related art (12800 to 13500 min⁻¹), thereby improving the work efficiency.

Although the invention has been described with reference to the embodiment, it can be understood by those skilled in the art that each constituting element or each process may be variously modified within the scope set forth in the claims. A modified embodiment will now be described hereinafter.

Regarding to the high output caused by the study on the shapes of the permanent magnet 23, the electric power tool is not limited to the impact driver illustrated in the embodiment, it may be applied to electric power tools of different types, and various parameters of the stator side are not limited thereto.

Further, as long as the permanent magnet 23 can satisfy the performance condition of 14600 to 19000 min⁻¹ as described above, the permanent magnet may be formed in a planar type (one for one pole), like the related art.

The present invention provides illustrative, non-limiting aspects as follows:

(1) In a first aspect, there is provided an electric power tool including: a motor; and a rotary impact mechanism configured to be driven by the motor, wherein the motor is configured such that a rotation speed thereof can be set within a range of 14600 to 19000 min⁻¹ when a motor torque is within a torque range during practical operation.

(2) In a second aspect, there is provided the electric tool according to the first aspect, wherein the motor is configured such that the rotation speed thereof can be set within the range of 14600 to 19000 min⁻¹ when the motor torque is within at least a portion of a torque range of 0.15 to 0.20 N·m.

(3) In a third aspect, there is provided the electric power tool according to the second aspect, wherein the motor is configured such that the rotation speed thereof can be set within the range of 14600 to 19000 min⁻¹ when the motor torque is within the entire torque range of 0.15 to 0.20 N·m.

(4) In a fourth aspect, there is provided the electric power tool according to the first aspect, wherein a duty ratio of applied voltage is 100% when the rotation speed of the motor is within the range of 14600 to 19000 min⁻¹ and the motor torque is within the torque range.

(5) In a fifth aspect, there is provided the electric power tool according to the first aspect, wherein an overall length of the electric power tool is within a range of 120 to 138 mm.

(6) In a sixth aspect, there is provided the electric power tool according to the first aspect, wherein a maximum voltage of a battery configured to drive the motor is within a range of 16 to 20V.

(7) In a seventh aspect, there is provided the electric power tool according to the first aspect, wherein the motor is a brushless motor, and wherein a stator of the motor has an outer diameter of 48.5±2 mm and has a tooth width within a range of 5.4 to 6.6 mm.

(8) In an eighth aspect, there is provided an electric power tool including: a motor; and a rotary impact mechanism configured to be driven by the motor, wherein the motor is a brushless motor, and wherein a stator of the motor has an outer diameter of 48.5±2 mm and has a tooth width of 5.4 to 6.6 mm.

(9) In a ninth aspect, there is provided the electric power tool according to the eighth aspect, wherein the stator has six slots.

(10) In a tenth aspect, there is provided the electric power tool according to the eighth aspect, wherein a number of turns of a coil of the stator is within a range of 8.5 to 11.5 turns per slot.

(11) In an eleventh aspect, there is provided the electric power tool according to the eighth aspect, wherein the coil of the stator has a wire diameter within a range of 1.1 to 1.3 mm.

(12) In a twelfth aspect, there is provided an electric power tool including: a brushless motor including: a shaft; a rotor core provided to an outer circumference of the shaft; and a plurality of permanent magnets each disposed in a magnet insertion portion of the rotor core and provided along an outer peripheral surface of the rotor core, wherein an outer peripheral side surface of each permanent magnet has a curved surface which is curved so that a center of curvature is located at the shaft side.

(13) In a thirteenth aspect, there is provided the electric power tool according to the twelfth aspect, wherein the magnet insertion portion is a groove formed to an outer peripheral surface of the rotor core, and wherein the curved surface of each permanent magnet is exposed from the magnet insertion portion.

(14) In a fourteenth aspect, there is provided the electric power tool according to the thirteenth aspect, wherein the outer peripheral side surface of each permanent magnet is provided with a stepped surface, which is recessed inwards from the curved surface, at one end side or both end sides of the curved surface in a direction about an axis of the shaft, and wherein the rotor core includes a locking portion which engages with the stepped surface to prevent each permanent magnet from being released from an outer circumferential side thereof.

(15) In a fifteenth aspect, there is provided the electric power tool according to the twelfth aspect, wherein at least a portion of an edge of each permanent magnet, when seen in an axial direction of the permanent magnet, is chamfered.

(16) In a sixteenth aspect, there is provided the electric power tool according to the twelfth aspect, wherein the rotor core has a partition which separates the adjacent permanent magnets from each other.

(17) In a seventeenth aspect, there is provided the electric power tool according to the twelfth aspect, wherein the curved surface is a substantially circular arc surface.

(18) In an eighteenth aspect, there is provided the electric power tool according to the twelfth aspect, wherein an inner peripheral side surface of each permanent magnet has a planar surface.

(19) In a nineteenth aspect, there is provided the electric power tool according to the twelfth aspect, further comprising a substantially T-shaped housing including: a power tool body; and a handle extending from the power tool body, wherein the brushless motor is provided rear to or extends to a portion of the power tool body to which the handle is attached.

(20) In a twentieth aspect, there is provided the electric power tool according to the nineteenth aspect, wherein an impact mechanism configured to be driven by the brushless motor is installed in the power tool body.

(21) In a twenty-first aspect, there is provided the electric power tool according to the twelfth aspect, wherein a battery pack serving as a power source is configured to be mounted to the electric power tool.

(22) In a twenty-second aspect, there is provided an electric power tool including: a brushless motor including: a shaft; a rotor core provided to an outer circumference of the shaft; and a plurality of permanent magnets each disposed in a magnet insertion portion of the rotor core and provided along an outer peripheral surface of the rotor core, wherein an outer peripheral side surface of each permanent magnet has a plurality of planar surfaces which are provided along a curved surface which is curved so that the center of curvature is located at the shaft side.

(23) In a twenty-third aspect, there is provided an electric power tool including: a brushless motor including: a shaft; a rotor core provided to an outer circumference of the shaft; and a plurality of permanent magnets each disposed in a magnet insertion portion of the rotor core and provided along an outer peripheral surface of the rotor core, wherein an outer peripheral side surface of each permanent magnet is a planar surface which is provided along a curved surface which is curved so that the center of curvature is located at the shaft side, and wherein, for one pole of the rotor, two or more permanent magnets of the same pole are provided.

What is claimed is:

1. An electric power tool comprising:
a motor; and
a rotary impact mechanism configured to be driven by the motor,
wherein the motor is configured such that a rotation speed thereof can be set within a range of 14600 to 19000 min⁻¹ when a motor torque is within a torque range during practical operation.

2. The electric tool according to claim 1,
wherein the motor is configured such that the rotation speed thereof can be set within the range of 14600 to 19000 min⁻¹ when the motor torque is within at least a portion of a torque range of 0.15 to 0.20 N·m.

3. The electric power tool according to claim 2,
wherein the motor is configured such that the rotation speed thereof can be set within the range of 14600 to 19000 min⁻¹ when the motor torque is within the entire torque range of 0.15 to 0.20 N·m.

4. The electric power tool according to claim 1,
wherein a duty ratio of applied voltage is 100% when the rotation speed of the motor is within the range of 14600 to 19000 min⁻¹ and the motor torque is within the torque range.

5. The electric power tool according to claim 1,
wherein an overall length of the electric power tool is within a range of 120 to 138 mm.

6. The electric power tool according to claim 1,
wherein a maximum voltage of a battery configured to drive the motor is within a range of 16 to 20V.

7. The electric power tool according to claim 1,
wherein the motor is a brushless motor, and
wherein a stator of the motor has an outer diameter of 48.5±2 mm and has a tooth width within a range of 5.4 to 6.6 mm.

8. An electric power tool comprising:
a motor; and
a rotary impact mechanism configured to be driven by the motor,
wherein the motor is a brushless motor, and
wherein a stator of the motor has an outer diameter of 48.5±2 mm and has a tooth width of 5.4 to 6.6 mm.

9. The electric power tool according to claim 8,
wherein the stator has six slots.

10. The electric power tool according to claim 8,
wherein a number of turns of a coil of the stator is within a range of 8.5 to 11.5 turns per slot.

11. The electric power tool according to claim 8,
wherein the coil of the stator has a wire diameter within a range of 1.1 to 1.3 mm.

12. An electric power tool comprising:
a brushless motor including:
a shaft;
a rotor core provided to an outer circumference of the shaft; and
a plurality of permanent magnets each disposed in a magnet insertion portion of the rotor core and provided along an outer peripheral surface of the rotor core,
wherein an outer peripheral side surface of each permanent magnet has a curved surface which is curved so that a center of curvature is located at the shaft side.

13. The electric power tool according to claim 12,
wherein the magnet insertion portion is a groove formed to an outer peripheral surface of the rotor core, and
wherein the curved surface of each permanent magnet is exposed from the magnet insertion portion.

14. The electric power tool according to claim 13,
wherein the outer peripheral side surface of each permanent magnet is provided with a stepped surface, which is recessed inwards from the curved surface, at one end side or both end sides of the curved surface in a direction about an axis of the shaft, and
wherein the rotor core includes a locking portion which engages with the stepped surface to prevent each permanent magnet from being released from an outer circumferential side thereof.

15. The electric power tool according to claim 12,
wherein at least a portion of an edge of each permanent magnet, when seen in an axial direction of the permanent magnet, is chamfered.

16. The electric power tool according to claim 12,
wherein the rotor core has a partition which separates the adjacent permanent magnets from each other.

17. The electric power tool according to claim 12,
wherein the curved surface is a substantially circular arc surface.

18. The electric power tool according to claim 12,
wherein an inner peripheral side surface of each permanent magnet has a planar surface.

19. The electric power tool according to claim 12, further comprising a substantially T-shaped housing including: a power tool body; and a handle extending from the power tool body,
wherein the brushless motor is provided rear to or extends to a portion of the power tool body to which the handle is attached.

20. The electric power tool according to claim 19,
wherein an impact mechanism configured to be driven by the brushless motor is installed in the power tool body.

21. The electric power tool according to claim 12,
wherein a battery pack serving as a power source is configured to be mounted to the electric power tool.

22. An electric power tool comprising:
a brushless motor including:
a shaft;
a rotor core provided to an outer circumference of the shaft; and
a plurality of permanent magnets each disposed in a magnet insertion portion of the rotor core and provided along an outer peripheral surface of the rotor core,
wherein an outer peripheral side surface of each permanent magnet has a plurality of planar surfaces which are provided along a curved surface which is curved so that the center of curvature is located at the shaft side.

23. An electric power tool comprising:
a brushless motor including:
a shaft;
a rotor core provided to an outer circumference of the shaft; and
a plurality of permanent magnets each disposed in a magnet insertion portion of the rotor core and provided along an outer peripheral surface of the rotor core,
wherein an outer peripheral side surface of each permanent magnet is a planar surface which is provided along a curved surface which is curved so that the center of curvature is located at the shaft side, and
wherein, for one pole of the rotor, two or more permanent magnets of the same pole are provided.
